(19) United States
(12) Patent Application Publication
(10) Pub. No.: US 2011/0140675 A1
(43) Pub. Date: Jun. 16, 2011

(54) Charging device for different batteries

(76) Inventor: Jen Yen Yen, Changhua Hsien (TW)

(21) Appl. No.: 12/653,269

(22) Filed: Dec. 10, 2009

(51) Int. Cl. H02J 7/04

(52) U.S. Cl. 320/162

(57) ABSTRACT

A battery charging device includes one or more current control converting circuits connected to a voltage stabilization circuit for controlling the charging current through the rechargeable batteries of different voltages or currents or types, one or more protection converting circuits or overcharging protection circuits for protecting the batteries from being overcharged, one or more uninterrupted and reverse charging prevented circuits for protecting the batteries from being charged backwardly, and one or more charging state instruction circuits for indicating the charging status of the batteries and for allowing the different types of rechargeable batteries to be charged with a single charging device.

### BACKGROUND OF THE INVENTION

1. Field of the Invention

The present invention relates to a charging device for batteries, and more particularly to a charging device for charging rechargeable batteries of different types, such as Ni-MH batteries, alkaline batteries, or the like and for allowing the different types of rechargeable batteries to be charged with a single charging device and for suitably reducing the cost for preparing the charging devices for charging the batteries of different types.

2. Description of the Prior Art

Various kinds of typical alkaline rechargeable batteries have been developed and used, such as nickel metal hydride (Ni-MH) cells or batteries, nickel cadmium (Ni—Cd) cells or batteries, alkaline batteries, or the like, and may include different voltages, currents, or other standards or specifications.

For charging the rechargeable batteries of different types or of different voltages, different currents, or other standards or specifications, different charging devices are required to be provided and prepared.

For example, U.S. Pat. No. 4,054,826 to Wahlstrom discloses one of the typical methods and apparatuses for charging batteries using variable capacitors and by converting random mechanical motion into electrical energy by utilizing gravitational and acceleration forces.

However, the typical battery charging methods and apparatuses may not distinguish the rechargeable batteries of different types or of different voltages, different currents, or other standards or specifications from each other.

U.S. Pat. No. 4,081,739 to Gahler discloses another typical circuit for quick charging of batteries and including voltage supply terminals for connection to a voltage source and battery connection terminals for connection to a battery to be charged.

However, the typical battery charging circuit also may not distinguish the rechargeable batteries of different types or of different voltages, different currents, or other standards or specifications from each other.

The present invention has arisen to mitigate and/or obviate the afore-described disadvantages of the conventional battery charging devices.

### SUMMARY OF THE INVENTION

The primary objective of the present invention is to provide a charging device for charging rechargeable batteries of different types, such as Ni-MH batteries, alkaline batteries, or the like and for allowing the different types of rechargeable batteries to be charged with a single charging device and for suitably reducing the cost for preparing the charging devices for charging the batteries of different types.

In accordance with one aspect of the invention, there is provided a charging device for a battery comprising a power input for supplying an electric energy, a polarity proving circuit electrically connected to the power input, a voltage stabilization circuit electrically connected to the polarity proving circuit for stabilizing the electric energy, a capacitance detection circuit electrically connected to the voltage stabilization circuit for detecting a capacitance remained in the battery, a battery detection and warning circuit electrically connected to the capacitance detection circuit for detecting whether the battery is damaged or not, an instruction converting circuit for charging state instruction electrically connected to the voltage stabilization circuit for indicating a charging status of the battery, at least one current control converting circuit for charging current control electrically connected to the voltage stabilization circuit for controlling a charging current through the battery, a protection converting circuit for protecting overcharging voltage electrically connected to the current control converting circuit for controlling and protecting the battery from being overcharged, an overcharging protection circuit electrically connected to the protection converting circuit and electrically connected to the battery for protecting and preventing the battery from being overcharged, an uninterrupted and reverse charging prevented circuit electrically connected to the overcharging protection circuit and electrically connected to the battery for protecting and preventing the battery from being charged backwardly, and a charging state instruction circuit electrically connected to the battery and electrically connected to the instruction converting circuit for charging state instruction for indicating a charging status of the battery.

The capacitance detection circuit includes at least one comparator for detecting the capacitance remained in the battery. The battery detection and warning circuit generates a warning signal to indicate that the battery has been damaged, such as generates a warning light, a warning sound or the like.

The instruction converting circuit for charging state instruction includes a switch for battery switching purpose. The current control converting circuit includes a switch for controlling the charging current through the battery.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a block diagram illustrating a charging device for batteries in accordance with the present invention; and

FIG. 2 is a plan schematic view illustrating an electric circuit of the charging device for batteries.

### DETAILED DESCRIPTION OF THE PREFERRED EMBODIMENT

Referring to the drawings, a charging device 1 for different types of rechargeable batteries in accordance with the present invention comprises a power input 10, such as a direct current (DC) 6V 800 mA power input 10 for providing or supplying the required power or energy to energize the charging device 1, a polarity proving circuit 11 electrically coupled or connected to the power input 10 for detecting or checking the polarities of the transformers or the voltages of the batteries 90, 91 to be charged and for preventing the charging device 1 from being powered or energized by different or wrong polarities or voltages and thus for preventing the charging device 1 from being damaged by the different or wrong polarities or voltages.

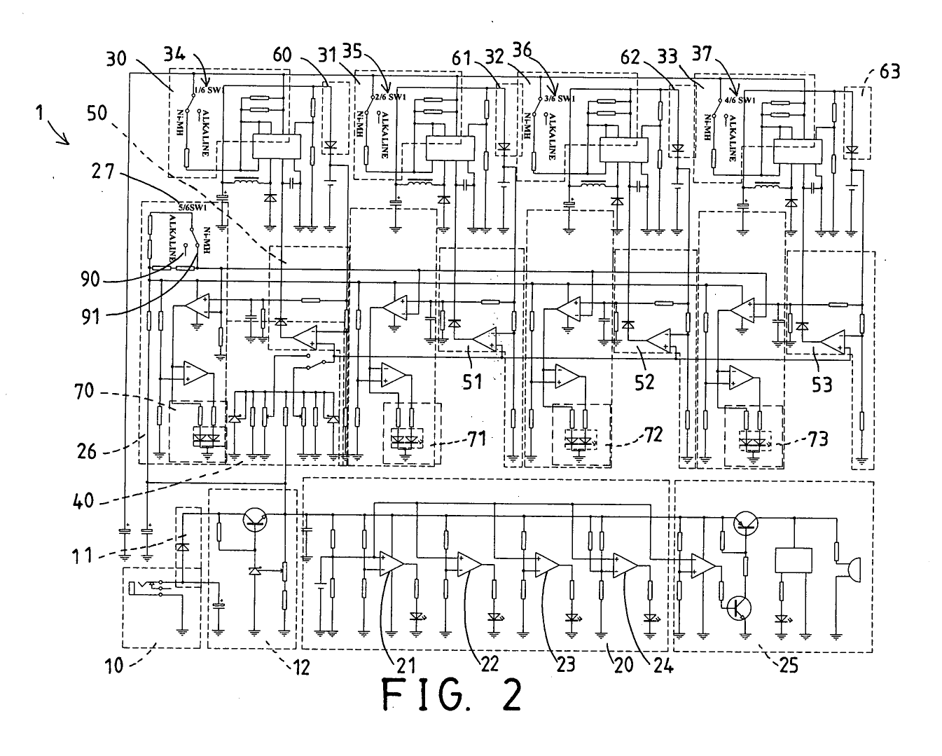

A voltage stabilization circuit 12 is electrically coupled or connected to the polarity proving circuit 11 for stabilizing the voltage and for providing or supplying the stabilized power or energy to energize the charging device 1 and for allowing the parts or elements or units of the charging device 1 to be worked properly. A capacitance detection circuit 20 is electrically coupled or connected to the voltage stabilization circuit 12 and includes one or more (such as four) comparators 21, 22, 23, 24 (FIG. 2) for sensing or detecting or checking the capacitance left or remained in the batteries 90, 91 to be charged, such as the AA/AAA batteries 90, 91 to be charged.

A battery detection and warning circuit 25 is electrically coupled or connected to the capacitance detection circuit 20 for sensing or detecting or checking whether the batteries 90, 91 are all right or not, or for sensing or detecting or checking whether the batteries 90, 91 are damaged or not, and may generate a warning signal, such as a warning light, a warning sound or the like in order to tell the user that the batteries 90, 91 may have been damaged. One or more (such as four) instruction converting circuits 26 for charging state instruction are electrically coupled or connected to the voltage stabilization circuit 12 and each include a switch 27, such as a ⅚SW 27 for switching between the alkaline battery (AAA) 90 and the Ni-MH battery (AA) 91 and for suitably instructing or indicating the charging statuses of the batteries 90, 91.

One or more (such as four) current control converting circuits 30, 31, 32, 33 for charging current control are electrically coupled or connected to the voltage stabilization circuit 12 and each includes a switch 34-37, such as a ⅙SW 34, 2/6SW 35, 3/6SW 36, 4/6SW 37 for switching between the alkaline battery (AAA) 90 and the Ni-MH battery (AA) 91 and for suitably controlling the charging current through the batteries 90, 91 to be charged. It is to be noted that the batteries 90, 91 of the alkaline battery (AAA) 90 or the Ni-MH battery (AA) 91 may include different charging current, and the converting circuits 30-33 may switch and control the suitable or predetermined charging current to flow through the batteries 90, 91 to be charged and for preventing the batteries 90, 91 from being charged by different or wrong current.

One or more (such as four) protection converting circuits 40, 41, 42, 43 for protecting overcharging voltage are electrically coupled or connected to the current control converting circuits 30-33 respectively for suitably controlling and protecting the batteries 90, 91 from being overcharged. It is to be noted that the batteries 90, 91 of the alkaline battery (AAA) or the Ni-MH battery (AA) may include different voltage, and the protection converting circuits 40-43 may protect and prevent the batteries 90, 91 from being overcharged by different voltages. One or more (such as four) overcharging protection circuits 50, 51, 52, 53 are electrically coupled or connected to the protection converting circuits 40-43 respectively and also electrically coupled or connected to the batteries 90, 91 for suitably protecting and preventing the batteries 90, 91 from being overcharged.

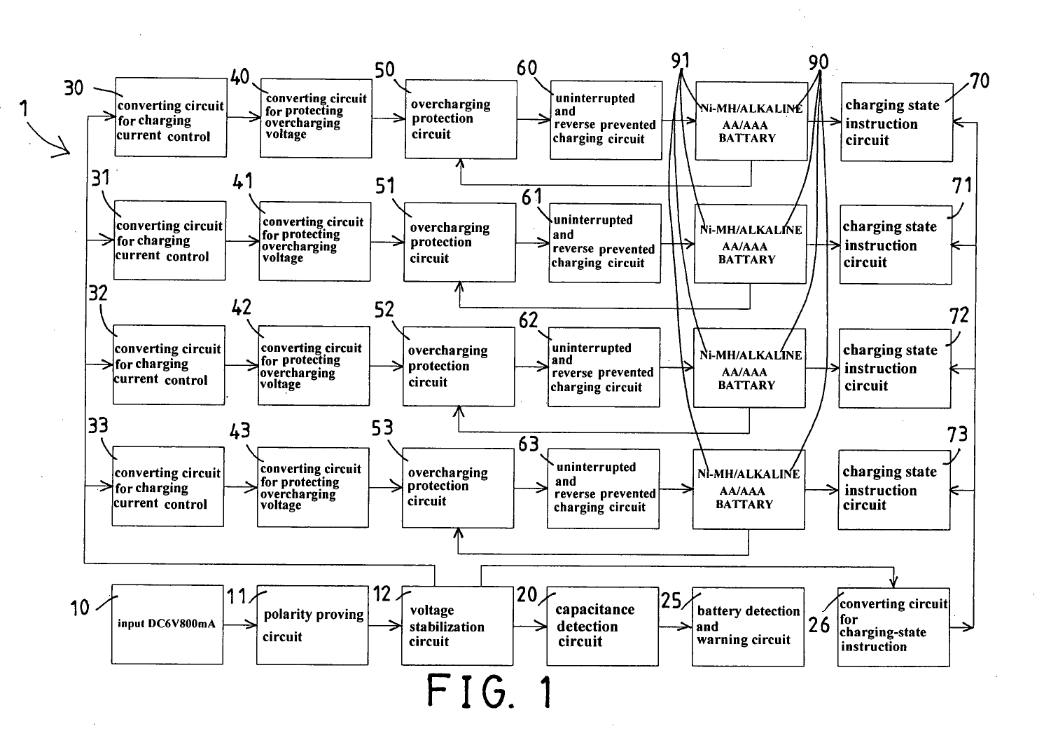

One or more (such as four) uninterrupted and reverse charging prevented circuits 60, 61, 62, 63 are electrically coupled or connected to the overcharging protection circuits 50-53 respectively and also electrically coupled or connected to the batteries 90, 91 for allowing four different batteries 90, 91 to be charged simultaneously and for suitably protecting and preventing the batteries 90, 91 from being charged backwardly or for preventing the electrical energy from being released from the batteries 90, 91 inadvertently, particularly when the power input 10 has become failure. As shown in FIG. 1, four or more different batteries 90, 91 of different voltages or different currents may be coupled in parallel and to be suitably charged simultaneously.

One or more (such as four) charging state instruction circuits 70, 71, 72, 73 are electrically coupled or connected to the batteries 90, 91 and also electrically coupled or connected to the charging state instruction converting circuits 26 for suitably instructing or indicating the charging statuses of the batteries 90, 91. For example, the charging state instruction circuits 70-73 may generate a red light to indicate that the batteries 90, 91 are in the charging status, and may generate a green light to indicate that the batteries 90, 91 have been suitably charged, and may generate a flashing red or green light to indicate that the batteries 90, 91 are about to be fully or completely charged.

In operation, as shown in the drawings, a single charging device 1 in accordance with the present invention may be used for charging one or more different rechargeable batteries 90, 91 of different voltages or different currents or different types simultaneously, or the rechargeable batteries 90, 91 may be randomly selected from different types or different voltages or different currents without additional charging devices such that the cost for preparing the charging devices and for charging the batteries of different types may be suitably reduced.

Accordingly, the charging device for batteries in accordance with the present invention may be provided for charging rechargeable batteries of different types, such as Ni-MH batteries, alkaline batteries, or the like and for allowing the different types of rechargeable batteries to be charged with a single charging device and for suitably reducing the cost for preparing the charging devices for charging the batteries of different types.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A charging device for a battery comprising:
a power input for supplying an electric energy,
a polarity proving circuit electrically connected to said power input,
a voltage stabilization circuit electrically connected to said polarity proving circuit for stabilizing said electric energy,
a capacitance detection circuit electrically connected to said voltage stabilization circuit for detecting a capacitance remained in said battery,
a battery detection and warning circuit electrically connected to said capacitance detection circuit for detecting whether said battery is damaged or not,
an instruction converting circuit for charging state instruction electrically connected to said voltage stabilization circuit for indicating a charging status of said battery,
at least one current control converting circuit for charging current control electrically connected to said voltage stabilization circuit for controlling a charging current through said battery,
a protection converting circuit for protecting overcharging voltage electrically connected to said at least one current control converting circuit for controlling and protecting said battery from being overcharged,
an overcharging protection circuit electrically connected to said protection converting circuit and electrically connected to said battery for protecting and preventing said battery from being overcharged,
an uninterrupted and reverse charging prevented circuit electrically connected to said overcharging protection circuit and electrically connected to said battery for protecting and preventing said battery from being charged backwardly, and
a charging state instruction circuit electrically connected to said battery and electrically connected to said instruction converting circuit for charging state instruction for indicating a charging status of said battery.

2. The charging device for batteries as claimed in claim 1, wherein said capacitance detection circuit includes at least one comparator for detecting the capacitance remained in said battery.

3. The charging device for batteries as claimed in claim 1, wherein said instruction converting circuit for charging state instruction includes a switch for battery switching purpose.

4. The charging device for batteries as claimed in claim 1, wherein said at least one current control converting circuit includes a switch for controlling the charging current through said battery.

5. The charging device for batteries as claimed in claim 1, wherein said battery detection and warning circuit generates a warning signal to indicate that the battery has been damaged.

6. The charging device for batteries as claimed in claim 5, wherein said battery detection and warning circuit generates a warning light.

7. The charging device for batteries as claimed in claim 5, wherein said battery detection and warning circuit generates a warning sound.
